(19) United States
(12) Patent Application Publication
(10) Pub. No.: US 2021/0094001 A1
(43) Pub. Date: Apr. 1, 2021

(54) DISC TUBE REVERSE OSMOSIS MODULE

(71) Applicants: CMT Membrane Technology (Xiamen) Co., Ltd., Xiamen (CN); Xiamen Jiarong Technology Corp., Ltd, Xiamen (CN); Xiamen University of Technology, Xiamen (CN)

(72) Inventors: Rushun WANG, Xiamen (CN); Zhiqun YUAN, Xiamen (CN); Jing ZHOU, Xiamen (CN); Bin YAN, Xiamen (CN); Zhipeng MA, Xiamen (CN); Tingliang ZHONG, Xiamen (CN)

(21) Appl. No.: 16/793,288

(22) Filed: Feb. 18, 2020

(30) Foreign Application Priority Data
Sep. 26, 2019 (CN) 201910915629.1

(51) Int. Cl. B01D 61/08; B01D 61/02; B01D 65/00

(52) U.S. Cl. CPC B01D 61/08; B01D 65/003; B01D 61/025

(57) ABSTRACT

A disc tube reverse osmosis module is provided. In various embodiments, deflector disc assemblies and associated membranes are sequentially alternately disposed from top to bottom. The upper flange is in sealing connection with the central pull rod, the upper lock nut is in threaded connection with an upper end of the central pull rod and located above the upper flange, the yielding water collecting pipe sleeves the central pull rod and is in sealing connection with a lower side of the lower flange, the lower lock nut is in threaded connection with a lower end of the central pull rod, an end of the yielding water receiving pipe is fixedly connected to the yielding water collecting pipe, an inner surface of the shell is respectively in sealing connection with the upper flange and the lower flange, and the water inlet receiving pipe and the concentrated liquid receiving pipe are fixed to the lower flange.

### CROSS REFERENCE TO RELATED APPLICATIONS

The present application claims the benefit of priority under 35 USC 119 to Chinese patent application 201910915629.1, filed Sep. 26, 2019, the contents of which are incorporated herein by reference.

### TECHNICAL FIELD

The present invention relates to the technical field of membrane modules, and in particular to a disc tube reverse osmosis module.

### BACKGROUND

In recent years, with the national environmental protection policies promulgated, wastewater treatment and discharge standards have been severely restricted. For the high-difficulty treatment of various kinds of wastewater, such as, leachate, high salt, high organic and high ammonia nitrogen wastewater, disc tube reverse osmosis membrane treatment technology has been widely used, due to its superior anti-fouling performance, the module's high-pressure resistance, and simple pretreat requirements. The pressure resistance and operating pressure of existing disc tube reverse osmosis membrane modules are generally within 9.0 MPa and 8.0 MPa, respectively. However, in order to increase the cycles of concentration, the operating pressure always needs to reach 16.0 MPa in many practical applications, which puts higher requirements on the strength of the module. What's more, higher requirements are also raised on the anti-pollution performance of membrane module for improving the feasibility of treating high-pollution wastewater.

A disc tube reverse osmosis membrane module is in such a configuration that a plurality of groups of hydraulic-discs, membrane-cushions, and seal rings are packaged together through a tie-rod, a top flange, an end flange, and lock nuts using a certain torque and then placed in a pressure vessel. The pressure resistance of the disc tube reverse osmosis membrane module is related to the strength of the top and end flanges, the tie-rod, hydraulic-discs, the membrane-cushions, hydraulic-disc seal rings, and seal rings.

Chinese Patent (No. CN204952673) discloses a membrane column and a high-pressure resistant membrane column. It claims that four auxiliary tension and compression mechanisms are added to the original tie-rod to make five tie-rods. Theoretically, this combination can increase the pressure resistance of the membrane module, but the different acting forces of the five tie-rods can result in uneven stress to the flanges, which causes a result that is not ideal. Pressing forces of the five tie-rods on the flanges, at both ends, are implemented through locking forces of respective nuts. As a result, the uneven stress of the flanges may cause failure problems, such as the failure of a seal, acceleration of deformation, and aging of the hydraulic-discs. Finally, the preferred high-pressure resistance cannot be realized.

Chinese patent (No. CN208356533 U) discloses a high-pressure resistant membrane column, which adds threaded baffle rings (No. 42) on the top flange and the end flange to disperse a force on the pressure vessel, and in order to achieve high pressure operation, a stainless steel material was adopted for the pressure vessel. This change can theoretically disperse the force to the pressure vessel to compensate for the tension resistance of the tie-rod, but it is difficult to achieve during implementation. Firstly, an anti-corrosive glass fiber reinforced plastic material needs to be replaced with an anti-corrosive stainless steel material, which greatly increases the cost of the pressure vessel; secondly, the inner surface of the stainless steel vessel should meet the requirements for high-pressure sealing, which causes high machining precision requirements and machining difficulty; thirdly, once the threaded baffle ring structure is adopted, it is troublesome when torque pre-tightening maintenance is performed on the hydraulic-discs; since a membrane module is vertically mounted, it is inconvenient to maintain the threaded baffle ring of the end flange. In addition, the tie-rod with threaded baffle ring structure also has a fatal flaw similar to the structure with the five rods. That is, the pre-tightening force of the baffle ring on the top flange and the end flange also have the problem of being always inconsistent or uneven, which also makes it impossible to implement in a preferred manner.

### SUMMARY

The objective of the inventive concepts is to provide a disc tube reverse osmosis module with high pressure and pollution resistance having a long service life, to solve the technical problems described above.

To achieve the above purpose, the inventive concepts provide the following technical solutions.

A disc tube reverse osmosis module includes a tie-rod, a top flange, an end flange, upper lock nuts, lower lock nuts, hydraulic-discs, membrane-cushions, a water inlet, a concentrate receiving pipe, a permeate collector, a permeate receiving pipe, and a pressure vessel, where both ends of the tie-rod have external threads. A hydraulic-disc assembly includes a hydraulic-disc and hydraulic-disc seal rings mounted in a lip seal groove on the hydraulic-disc. The hydraulic-disc assemblies and the membrane-cushions are sequentially alternately disposed and coaxially sleeve the outside of the tie-rod from top to bottom. The number of the hydraulic-discs assemblies is one more than that of the membrane-cushions; the top flange and the end flange sleeve the tie-rod and clamp the hydraulic-discs assemblies and the membrane-cushions there between; the top flange is in sealing connection with the tie-rod; the upper lock nut is in threaded connection with the top of the tie-rod and located above the top flange; the upper lock nut is configured to exert downward locking force on the top flange; and a plurality of water distribution ports are evenly distributed in a circumferential direction on the edge of the lower surface of the top flange; a gap is reserved between the end flange and the tie-rod; the permeate collector sleeves the tie-rod and is in sealing connection with the lower side of the end flange, and a gap is reserved between the end of the permeate collector which is adjacent to the end flange and the tie-rod; the lower lock nut is in threaded connection with the lower end of the tie-rod and located below the permeate collector, and the lower lock nut is configured to exert an upward locking force on the permeate collector; one end of the permeate receiving pipe is fixedly connected to the permeate collector, it is communicated with the gap between the permeate collector and the tie-rod; the inner surface of the pressure vessel is respectively in sealing connection with the top flange and the end flange, and a gap is reserved between the hydraulic-discs and the pressure vessel; the water inlet and the concentrate receiving pipe are fixed on the end flange, the end flange is provided with a water inlet flow channel and a water outlet flow channel; the water inlet is communicated with the gap between the hydraulic-discs and the pressure vessel through the water inlet flow channel, and the concentrate receiving pipe is communicated with a water distribution groove on the hydraulic-discs through the water outlet flow channel.

Preferably, the top flange and the end flange are each in sealing connection with the pressure vessel through a lip seal in a mounting groove corresponding to the lip seal, and openings of the two lip seals are oppositely disposed.

Preferably, a top flange sealing shaft sleeve is disposed between the top flange and the tie-rod; the top flange sealing shaft sleeve sleeves the tie-rod; the inner side of the top flange sealing shaft sleeve is in sealing connection with the tie-rod through an inner seal ring in the sleeve; the outer side of the top flange sealing shaft sleeve is in sealing connection with the top flange through an outer seal ring of the sleeve, and the top flange sealing shaft sleeve is provided with a seal ring groove for mounting the inner seal ring and the outer seal ring of the sleeve.

Preferably, the disc tube reverse osmosis module further includes a tie-rod cushion block, where the cushion block sleeves the outer side of the tie-rod, and both ends of the cushion block abut against the upper lock nut and the top flange, respectively.

Preferably, an end of the permeate collector that is away from the end flange is in sealing connection with the tie-rod through an inner seal ring of the permeate collector; a groove is disposed at the center of the lower surface of the end flange; the end of the permeate collector close to the end flange abuts against the bottom of the groove and is in sealing connection with a groove wall through an outer seal ring of the permeate collector, and the permeate collector is provided with a seal ring groove for mounting the inner and the outer seal rings.

Preferably, the hydraulic-disc includes: a hydraulic-disc body, where bulges are arranged on both the front side and back side; the multiple bulges are annularly and uniformly distributed by taking the center of the hydraulic-disc body as the center of a circle, there are the same cycle numbers of the bulges on the front side and the back side of the hydraulic-disc body, and diameters of the cycles of the bulges are mutually corresponding; radial water distribution ribs, where multiple radial water distribution ribs are annularly and uniformly distributed by taking the center of the hydraulic-disc body as the center of a circle, a water distribution groove is formed between two adjacent water distribution ribs, and a first end of each radial water distribution rib is fixedly connected with an inner edge of the hydraulic-disc body; and an inner support ring, where a second end of each radial water distribution rib is fixedly connected with the outer edge of the inner support ring, an annular boss is arranged on the front side of the inner support ring, a hydraulic-disc seal ring groove is respectively arranged at corresponding positions of the front side and back side of the inner support ring, the outer side groove wall of the hydraulic-disc seal ring groove is serrated, the hydraulic-disc seal ring groove is located on the outer side of the annular boss, multiple permeate receiving grooves are annularly and uniformly distributed on the inner surface of the inner support ring, the permeate receiving grooves are axial through grooves, the depth of the permeate receiving groove is greater than the width of the annular boss, locating pins and locating holes are arranged on the front side and the back side of the annular boss, respectively and the locating holes are used for allowing insertion of the locating pins.

An outer support ring, where the inner edge of the outer support ring is fixedly connected with the outer edge of the hydraulic-disc body, and the inner support ring, the outer support ring, the hydraulic-disc body, the annular boss and the hydraulic-disc seal ring grooves are concentric.

Preferably, the membrane-cushion includes two reverse osmosis membrane-cushions and a supporting net; the supporting net is clamped between the two reverse osmosis membrane-cushions; the supporting net and the reverse osmosis membrane-cushions have a concentric annular structure, and the two reverse osmosis membrane-cushions are connected to the outer edge of the supporting net by ultrasonic welding.

Preferably, the innermost cycle of the bulges on the front side and the back side of the hydraulic-disc body and the corresponding radial water distribution ribs have the same position angles.

Preferably, there are two position relations of each cycle of the bulges on the front side and the back side of the hydraulic-disc body and the radial water distribution ribs. One position relation is: any bulge of the cycle and one radial water distribution rib have the same position angle, and the other position relation is: any bulge of the cycle is located on the central surface of the water distribution groove. The two position relations are distributed alternatively.

Preferably, the hydraulic-disc seal ring is made of nitrile rubber, containing the following preparation raw materials in parts by mass:

100 parts of raw nitrile rubber;

0.1-5 parts of liquid nitrile rubber-modified graphene oxide;

60-90 parts of liquid nitrile rubber-modified carbon black;

1-3 parts of anti-aging agent;

2-6 parts of compound vulcanizing agent; and

1-3 parts of accelerator.

Aspects of the present invention achieve the following technical effects compared with the existing techniques: the bulges on the hydraulic-disc play a spoiler role that can improve the anti-pollution capability of the hydraulic-discs and the membrane-cushions and can prolong their service lives; the pressure resistance of the disc tube reverse osmosis module is improved by the improvement of the structure of the seal ring groove and the material of the seal ring, and the sealing pressure can reach 25.0 Mpa; the problem of uneven stress in a circumferential direction of the top flange and the end flange resulting from the adoption of a plurality of rods is solved by applying a pre-tightening force on the centers of the top flange and the end flange through a single tie-rod.

### BRIEF DESCRIPTION OF THE DRAWINGS

The inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a schematic structural diagram of a front side of a hydraulic-disc according to aspects of the present invention;

FIG. 2 is a schematic structural diagram of a back side of a hydraulic-disc according to aspects of the present invention;

FIG. 3 is a schematic structural diagram of a bulge according to aspects of the present invention;

FIG. 4 is a cross-sectional view of a partial structure after assembly of a hydraulic-disc, a hydraulic-disc seal ring and a membrane-cushion according to aspects of the present invention;

FIG. 5 is a schematic structural diagram of a front side of a hydraulic-disc after the installation of a membrane-cushion according to aspects of the present invention;

FIG. 6 is a schematic three-dimensional diagram of a front side structure of a hydraulic-disc according to aspects of the present invention;

FIG. 7 is a schematic diagram of a superimposed effect after assembly of a plurality of hydraulic-discs according to aspects of the present invention;

FIG. 8 is a schematic structural diagram of a membrane-cushion according to aspects of the present invention;

FIG. 9 is a schematic diagram of an overall structure of a disc tube reverse osmosis module according to aspects of the present invention;

FIG. 10 is a schematic structural diagram of a top flange according to aspects of the present invention;

FIG. 11 is a schematic structural diagram of an end flange according to aspects of the present invention; and

FIG. 12 is a schematic diagram of an internal water flow direction of a disc tube reverse osmosis module according to aspects of the present invention.

### DESCRIPTION OF REFERENCE NUMERALS

1. hydraulic-disc body,
2. radial water distribution rib,
3. inner support ring,
4. outer support ring,
5. hydraulic-disc seal ring groove,
6. locating pin,
7. locating hole,
8. axial through groove,
9. water distribution groove,
10. bulge,
11. first location indicating structure,
12. second location indicating structure,
13. membrane-cushion,
14. hydraulic-disc seal ring,
15. tie-rod,
16. upper lock nut,
17. tie-rod cushion block,
18. top flange,
19. outer seal ring of the top flange sealing shaft sleeve,
20. top flange sealing shaft sleeve,
21. inner seal ring of the top flange sealing shaft sleeve;
22. lip seal,
23. lower lock nut,
24. hydraulic-disc,
25. end flange,
26. outer seal ring of a permeate collector,
27. concentrate receiving pipe,
28. permeate collector,
29. inner seal ring of the permeate collector,
30. permeate receiving pipe,
31. water inlet.

### DETAILED DESCRIPTION

The following describes one or more technical solutions in accordance with aspects of the present invention, with reference to the accompanying drawings. The described embodiments are merely some, rather than all, of the possible embodiments of the present invention. All other embodiments obtained by general technical personnel in the field based on the embodiments described herein, without any creativity, shall fall within the scope of protection of the present invention.

According to objectives of the present invention, provided is a disc tube reverse osmosis module which is resistant to high pressure and pollution and has a long service life, to solve the technical problems of the existing techniques described above.

In order to make the above objectives, features, and advantages of the present invention more apparent, aspects of the present invention will be further described in detail in conjunction with the accompanying drawings and the detailed description.

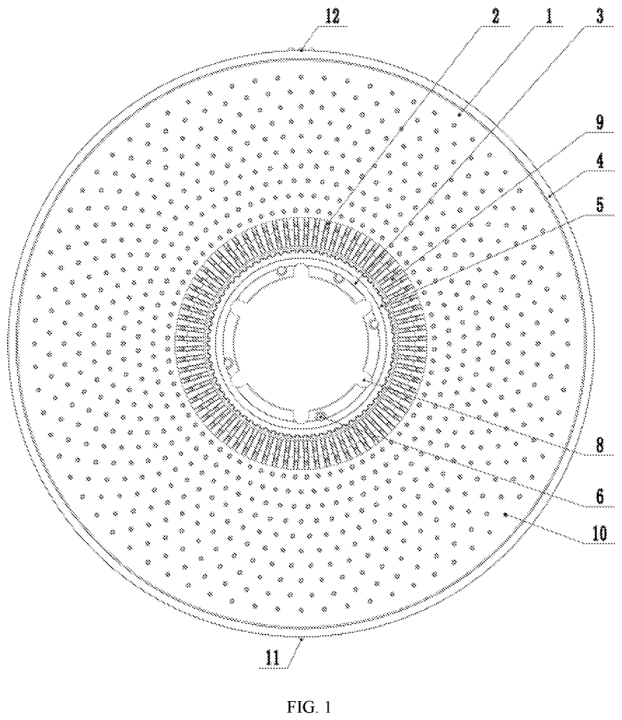

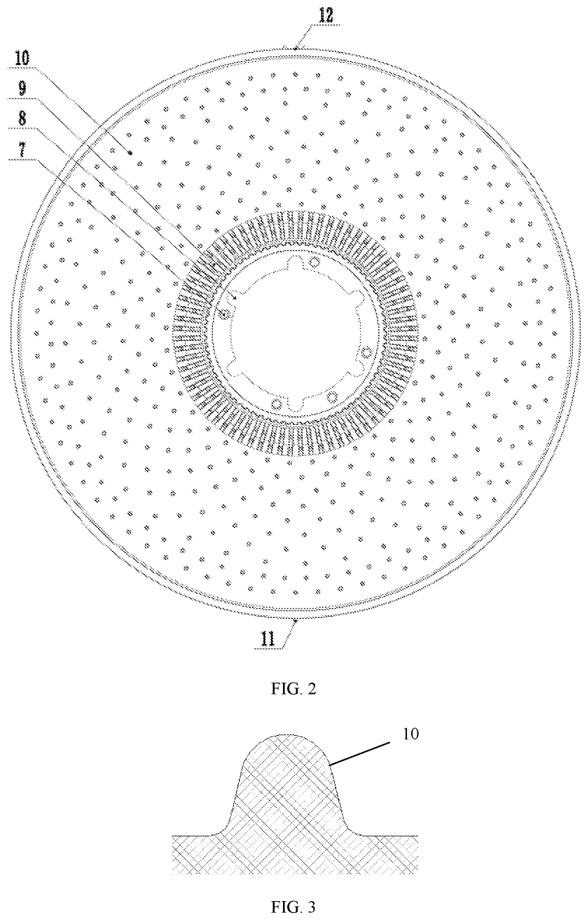

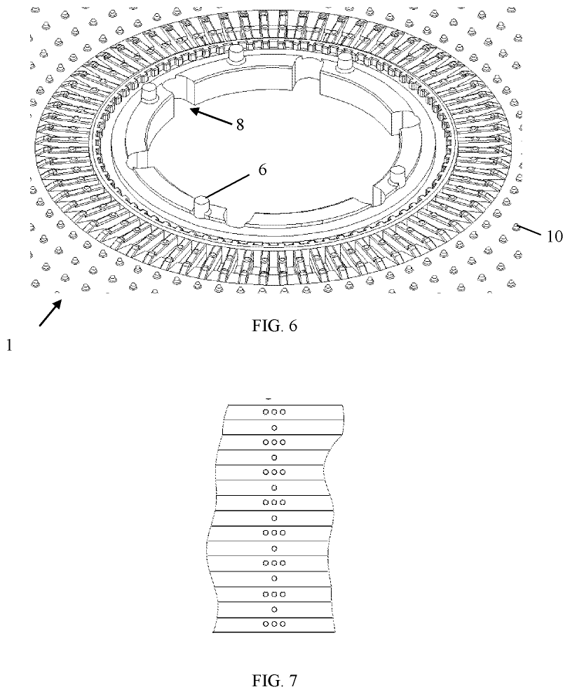

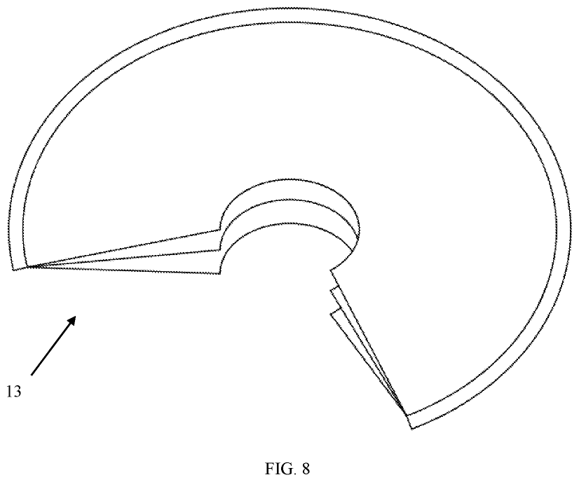

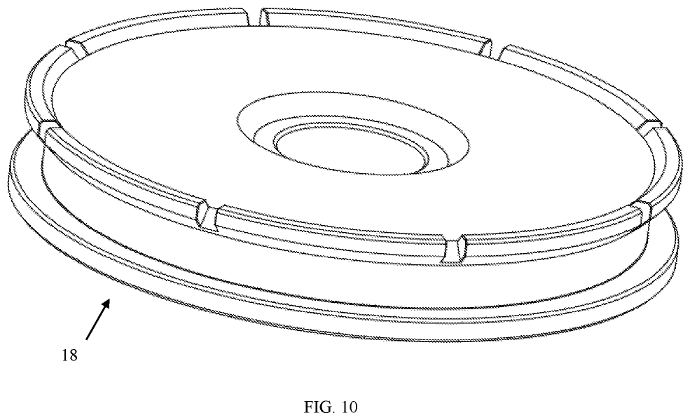

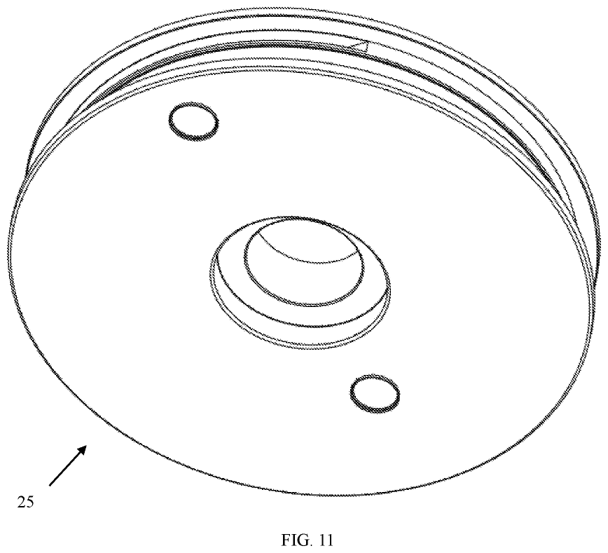

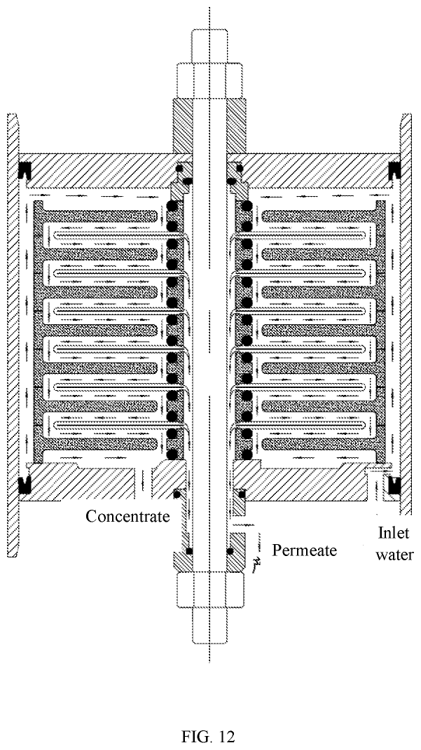

As shown in FIGS. 1-12, provided is a disc tube reverse osmosis module, including a tie-rod 15, a top flange 18, an end flange 25, an upper lock nut 16, a lower lock nut 23, hydraulic-disc assemblies, membrane-cushions 13, a water inlet 31, a concentrate receiving pipe 27, a permeate collector 28, a permeate receiving pipe 30, and a pressure vessel.

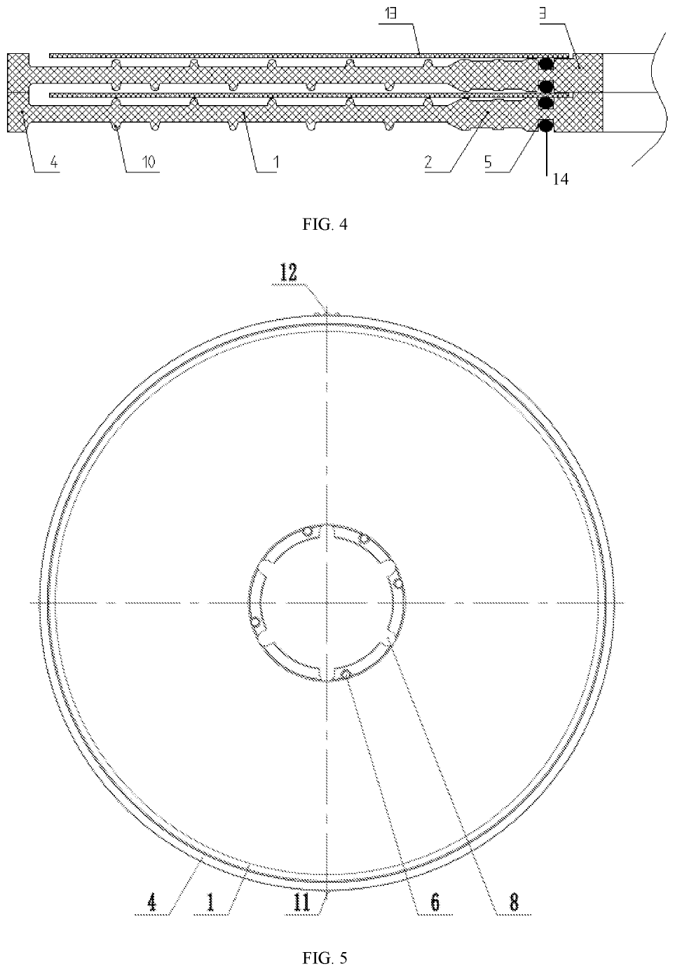

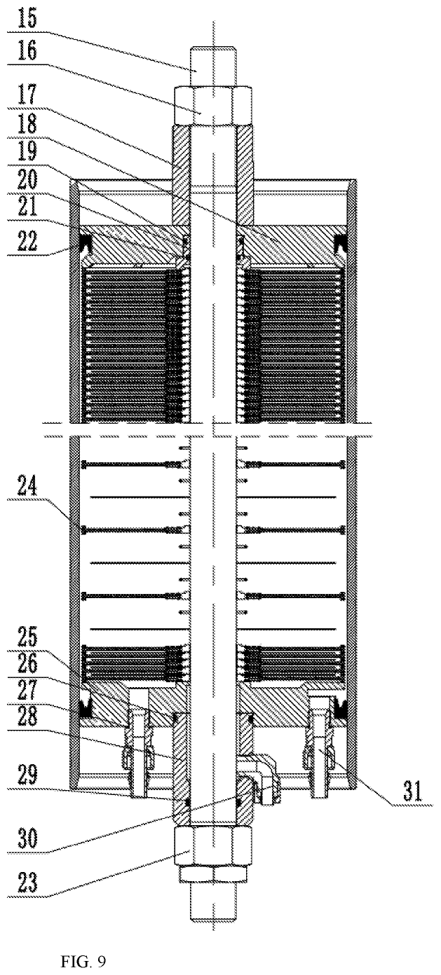

Both ends of the tie-rod 15 have external threads for threaded connection with the upper lock nut 16 and the lower lock nut 23, respectively. A hydraulic-disc assembly includes a hydraulic-disc 24 and a hydraulic-disc seal ring 14 mounted in a hydraulic-disc seal ring groove 5 on the hydraulic-disc 24. A plurality of the hydraulic-disc assemblies and the membrane-cushions 13 are sequentially alternately disposed from top to bottom and coaxially sleeve on the outside of the tie-rod 15, e.g., see FIGS. 4 and 9. To prevent the impact of water flow, no membrane 13 is disposed above the uppermost hydraulic-disc assembly. That is, in the present embodiment, the number of the hydraulic-disc assemblies is one more than that of the membrane-cushions 13. The top flange 18 and the end flange 25 sleeve the tie-rod 15 and clamp the hydraulic-disc assemblies and the membrane-cushions 13 there between. The top flange 18 is in a sealing connection with the tie-rod 15, and the upper lock nut 16 is in threaded connection with the upper end of the tie-rod 15 and located above the top flange 18. The upper lock nut 16 is configured to exert a downward locking force on the top flange 18, and a plurality of water distribution ports are evenly distributed in a circumferential direction on the edge of a lower surface of the top flange 18.

A gap is reserved between the end flange 25 and the tie-rod 15. A permeate collector 28 sleeves the tie-rod 15 and is in sealing connection with a lower side of the end flange 25. A gap is reserved between an end of the permeate collector 28 adjacent to the end flange 25 and the tie-rod 15. The lower lock nut 23 is in threaded connection with the lower end of the tie-rod 15 and located below the permeate collector 28. The lower lock nut 23 is configured to exert an upward locking force on the permeate collector 28.

An end of the permeate receiving pipe 30 is fixedly connected to the permeate collector 28, and an end of the permeate receiving pipe 30 is in fluid communication with the gap between the permeate collector 28 and the tie-rod 15. The inner surface of the pressure vessel is respectively in sealing connection with the top flange 18 and the end flange 25, and a gap is reserved between the hydraulic-disc 24 and the pressure vessel. The water inlet 31 and the concentrate receiving pipe 27 are fixed on the end flange 25. The end flange 25 is provided with a water inlet flow channel and a water outlet flow channel. The water inlet 31 is in fluid communication with the gap between the hydraulic-disc 24 and the pressure vessel through the water inlet flow channel. The concentrate receiving pipe 27 is in fluid communication with a water distribution groove 9 on the hydraulic-disc 24 through the water outlet flow channel.

Through the upper lock nut 16 and the lower lock nut 23, the hydraulic-disc assemblies and the membrane-cushions 13 are packaged together with a certain torque to form a membrane core, and the entire membrane core is placed in the pressure vessel to form a complete disc tube reverse osmosis membrane module.

When the disc tube reverse osmosis module in accordance with the present invention is used, a water source is in fluid communication with the water inlet 31. After inlet water flows through the water inlet flow channel on the end flange 25, since the gap is reserved between the hydraulic-disc 24 and the pressure vessel, the inlet water flows upwards along the gap between the hydraulic-disc assembly and the pressure vessel (after the hydraulic-discs 24 are stacked, an outer support ring 4 thereof forms a cylindrical structure), until the inlet water flows to the top flange 18. The plurality of water distribution ports are evenly distributed in the circumferential direction on the edge of the lower surface of the top flange 18, wherein a radial width of the water distribution port should be greater than that of the outer support ring 4 of the hydraulic-discs 24. The inlet water passes through the water distribution port and then flows to an inner side of the outer support ring 4 of the hydraulic-discs 24. Since the hydraulic-discs 24 are provided with the water distribution grooves 9, the inlet water flows from the periphery to the center along the lower surface of the top flange 18, passes through the water distribution groove 9 of the hydraulic-disc 24 of the uppermost layer downwards, flows from the center to the periphery along the upper surface of the membrane 13 of the uppermost layer, flows from the periphery to the center along the lower surface of the membrane 13, and then passes through the water distribution groove 9 of the hydraulic-disc 24 of the second layer downwards.

The inlet water flows accordingly, until the inlet water passes through the water distribution groove 9 of the hydraulic-disc 24 of the bottommost layer downwards, and a concentrated liquid flows out through the water outlet flow channel on the end flange 25 and the concentrate receiving pipe 27. Permeate filtered by the membrane-cushions 13 flows downwards along a permeate collecting groove between the tie-rod 15 and the hydraulic-disc 24 (an inner side of an inner support ring 3 of the hydraulic-disc 24 is provided with the permeate collecting groove extending in an axial direction), and flows out through the permeate collector 28 and the permeate receiving pipe 30.

In order to improve the sealing property, in various embodiments, the top flange 18 and the end flange 25 are each in sealing connection with the pressure vessel through a lip seal 22. The top flange 18 and the end flange 25 are each provided with a mounting groove corresponding to the lip seal 22, and openings of the two lip seals 22 are oppositely disposed.

Further, in the present invention, the top flange sealing shaft sleeve 20 is disposed between the top flange 18 and the tie-rod 15. The tie-rod 15 is sleeved with the top flange sealing shaft sleeve 20. An inner side of the top flange sealing shaft sleeve 20 is in sealing connection with the tie-rod 15 through an inner seal ring 21 of the top flange sealing shaft sleeve. An outer side of the top flange sealing shaft sleeve 20 is in sealing connection with the top flange 18 through an outer seal ring 19 of the top flange sealing shaft sleeve. And the top flange sealing shaft sleeve 20 is provided with a seal ring groove for mounting the inner seal ring 21 of the top flange sealing shaft sleeve and the outer seal ring 19 of the top flange sealing shaft sleeve. Those skilled in the art can also select other commonly used sealing structures as intermediate structures as long as the sealing connection of the top flange 18 and the tie-rod 15 can be achieved.

Further, an inner side of an end of the permeate collector 28 away from the end flange 25 is in sealing connection with the tie-rod 15 through an inner seal ring 29 of the permeate collector, a groove is disposed at the center of the lower surface of the end flange 25, an end of the permeate collector 28 close to the end flange 25 abuts against a groove bottom of the groove and is in sealing connection with a groove wall of the groove through an outer seal ring 26 of the permeate collector, and the permeate collector 28 is provided with a seal ring groove for mounting the inner seal ring 29 of the permeate collector and the outer seal ring 26 of the permeate collector.

The upper lock nut 16 may be in direct contact with the top flange 18, or an intermediate structure may be disposed between the upper lock nut 16 and the top flange 18. The embodiment further includes a tie-rod cushion block 17. The tie-rod cushion block 17 sleeves an outer side of the tie-rod 15, and both ends of the tie-rod cushion block 17 abut against the upper lock nut 16 and the top flange 18, respectively. That is, the tie-rod cushion block 17 is used as the intermediate structure between the upper lock nut 16 and the top flange 18.

In order to further improve the pressure resistance of the disc tube reverse osmosis module, the structure of the hydraulic-disc 24 is also improved. The front and back sides of the hydraulic-disc body 1 are provided with bulges 10. The plurality of bulges 10 are annularly evenly distributed, with the center of the hydraulic-disc body 1 being a circle center defining an opening. In a preferred embodiment, the bulges 10 on the front and back sides of the hydraulic-disc body 1 have the same number of turns, and the diameter of each turn corresponds to each other. When the inlet water flows on the front and back sides of the hydraulic-disc body 1, the bulges 10 can function of creating turbulence to achieve the effect of cleaning the hydraulic-disc body 1 and the membrane 13. After the membrane 13 is mounted between two adjacent hydraulic-discs 24, since the bulges 10 on the front and back sides of the hydraulic-disc body 1 have the same turn diameter, the bulges 10 on the front and back sides of the hydraulic-disc body 1 limit the membrane 13 and can prevent the damage to the membrane 13 resulting from a large displacement of the membrane 13 under the action of the turbulence. Since the membrane module is usually vertically installed in practical applications, in order to effectively prevent the deposition of contaminants on the front of the hydraulic-disc, the number of the bulges 10 on the front of the hydraulic-disc body 1 can be greater than that of the bulges 10 on the back side of the hydraulic-disc body 1. In order to prevent the membrane 13 from being damaged during contact with the bulge 10, the bulge 10 has a structure shrunk from bottom to top, the bottom of the bulge 10 is in circular arc transition with the hydraulic-disc body 1, and the top of the bulge 10 is a curved surface.

A plurality of radial water distribution ribs 2 are annularly evenly distributed with the center of the hydraulic-disc body 1. A water distribution groove 9 is formed between two adjacent water distribution ribs, and a first end of the radial water distribution rib 2 is fixedly connected to an inner edge of the hydraulic-disc body 1. The inlet water can flow to the hydraulic-disc 24 of a next stage through the water distribution groove 9.

A second end of the radial water distribution rib 2 is fixedly connected to an outer edge of the inner support ring 3, and the front of the inner support ring 3 is provided with an annular boss. A height of the annular boss cannot be less than a thickness of the membrane 13, ensuring that the membrane 13 is not crushed by the hydraulic-discs 24 on upper and lower sides during assembly. One hydraulic-disc seal ring groove 5 is disposed at each of corresponding positions of front and back sides of the inner support ring 3, and the hydraulic-disc seal ring groove 5 is configured to accommodate a hydraulic-disc seal ring 14. When assembled, the membrane 13 is not directly fixed by the inner support ring 3, the hydraulic-disc seal ring 14 mounted on the front of the hydraulic-disc 24 and the hydraulic-disc seal ring 14 mounted on the back side of another hydraulic-disc 24 clamp the membrane 13 therebetween. The inside of the hydraulic-disc seal ring 14 is provided with a permeate channel, and the outside of the hydraulic-disc seal ring 14 is provided with a concentrated liquid flow channel. The diaphragm 13 is in a natural state in a direction from the center to the circumference in an interval limited by circles of the bulges 10 of the same diameter on one upper hydraulic-disc 24 and one lower hydraulic-disc 24.

In accordance with aspects of the inventive concepts, an improvement of the hydraulic-disc 24 is that an outer side groove wall of the hydraulic-disc seal ring groove 5 is in a sawtooth shape, and an inner side groove wall of the hydraulic-disc seal ring groove 5 is a cylindrical surface. When the hydraulic-disc seal ring 14 is mounted in the hydraulic-disc seal ring groove 5, the hydraulic-disc seal ring 14 is pressed and deformed under the action of an external torque. The hydraulic-disc seal ring 14 fills sawteeth, and a contact area of the hydraulic-disc seal ring 14 and the hydraulic-disc seal ring groove 5 is increased, so that the hydraulic-disc seal ring 14 does not slip easily in a high pressure state, thereby improving the sealing capacity of the hydraulic-disc seal ring 14 under high pressure. The width and depth of the outer side groove wall sawtooth structure are preferably sufficient to accommodate an amount of deformation of the hydraulic-disc seal ring 14. When high-pressure water flow of the water distribution groove 9 impacts towards the hydraulic-disc seal ring 14, since the hydraulic-disc seal ring 14 fills the sawtooth-shaped grooves, a good protection effect on a seal ring in the hydraulic-disc seal ring groove 5 is achieved. Therefore, in the present invention, through the arrangement of the hydraulic-disc seal ring groove 5 with the sawtooth-shaped outer side groove wall, a very good protection effect is achieved while the deformation of the hydraulic-disc seal ring 14 is effectively absorbed, ensuring the sealing reliability in a high pressure state.

The membrane 13 includes two reverse osmosis membrane-cushions and a supporting net. The supporting net is clamped between the two reverse osmosis membrane-cushions. The two reverse osmosis membrane-cushions are connected to an outer edge of the supporting net by ultrasonic welding, and an inner edge is open. The supporting net enables permeate of the membrane 13 to quickly flow to a center outlet, and the supporting net and the reverse osmosis membrane-cushions have a concentric annular structure. The hydraulic-disc seal ring groove 5 is located outside the annular boss, a plurality of permeate collecting grooves are annularly evenly distributed on an inner surface of the inner support ring 3, and the permeate collecting grooves are axial through grooves 8 and pass through the annular boss in a radial direction. Permeate flows axially through grooves 8 along the supporting net between the two reverse osmosis membrane-cushions, the hydraulic-disc seal ring 14 in the hydraulic-disc seal ring groove 5 prevents a feed liquid from entering the axial through grooves 8, and permeate channeled through the axial grooves 8 is finally collected and discharged through the permeate receiving pipe 30. In the present embodiment, the number of the permeate collecting grooves is six, and the permeate collecting grooves are evenly distributed in a circumferential direction about the inner surface of the inner support ring 3.

In order to facilitate the positioning and installation of two adjacent hydraulic-discs 24, the front of the annular boss is provided with locating pins 6, the back side of the annular boss is provided with locating holes 7 within which the locating pins 6 are to be inserted, and pin holes of two adjacent hydraulic-discs 24 are used for positioning.

Specifically, the number of the locating pins 6 of the present invention is five, and central angles corresponding to two adjacent locating pins 6 are sequentially 45 degrees, 45 degrees, 90 degrees, 90 degrees, and 90 degrees in the clockwise direction. The number of the locating holes 7 of the present invention is five, and central angles corresponding to two adjacent locating holes 7 are also sequentially 45 degrees, 45 degrees, 90 degrees, 90 degrees, and 90 degrees in the clockwise direction. However, the positions of the five locating holes 7 on the annular boss entirely differ from the positions of the five locating pins 6 on the annular boss by 180 degrees.

In order to facilitate alignment and counting, the outer side surface of the outer support ring 4 is provided with a first location indicating structure 11 and a second location indicating structure 12, and a connecting line of the first location indicating structure 11 and the second location indicating structure 12 is in the direction of the diameter of the outer support ring 4 and is collinear with a connecting line of two of the permeate collecting grooves. The first location indicating structure 11 and the second location indicating structure 12 are different. The first location indicating structure 11 is a bump and the second location indicating structure 12 is three bumps. After the locating pins 6 are inserted in the locating holes 7, the first location indicating structures 11 and the second location indicating structures 12 of the upper and lower hydraulic-discs 24 are mounted in a staggered mode.

An inner edge of the outer support ring 4 is fixedly connected to an outer edge of the hydraulic-disc 24. The inner support ring 3, the outer support ring 4, the hydraulic-disc body 1, the annular boss and the hydraulic-disc seal ring groove 5 are concentric. A concave portion is formed between the outer support ring 4 and the annular boss on the front of a deflector ring body to accommodate the membrane 13. That is, an outer diameter of the membrane 13 is smaller than an inner diameter of the outer support ring 4, and an inner diameter of the membrane 13 is greater than an outer diameter of the annular boss.

In order to ensure that the inner support ring 3 and the outer support ring 4 are evenly stressed and do not deform when the hydraulic-disc 24 is mounted on the disc tube reverse osmosis membrane module, in the present invention, the inner support ring 3 and the outer support ring 4 have the same thickness, the back side of the inner support ring 3 and the back side of the outer support ring 4 are coplanar, and the front of the annular boss and the front of the outer support ring 4 are coplanar.

In order to ensure the pressure difference resistance of the hydraulic-discs 24, the outer support rings 4 on both sides of the hydraulic-disc body 1 preferably have the same thickness, so that the plurality of hydraulic-discs 24 are assembled together and are stressed evenly when compressed by a torque.

Further, for the distribution form of the bulges 10, the bulges 10 on the innermost turn on the front and back sides of the hydraulic-disc body 1 have the same position angles corresponding to the radial water distribution ribs 2. When the feed liquid is diffused in the direction from the center to the circumference or in the direction from the circumference to the center, the fierce tumbling of water flow resulting from the direct impact of the feed liquid coming in and out of the water distribution rib to the bulges 10 can be avoided, thereby avoiding the damage to the membrane 13.

Further, there are two positional relationships between each turn of bulges 10 on the front and back sides of the hydraulic-disc body 1 and the radial water distribution ribs 2. One is that any of the bulges 10 of the turn has the same position angle as one of the radial water distribution ribs 2, the other is that any of the bulges 10 of the turn is located on a center plane of the water distribution groove 9, and the two positional relationships are alternately distributed. In this point distribution mode, the feed liquid does not flow in a linear and stable flowing mode when passing through the hydraulic-disc 24. No matter whether the feed liquid flows from the periphery of the front of the hydraulic-disc 24 to the center or flows from the center of the back side of the hydraulic-disc 24 to the periphery, ring-by-ring turbulent bulges 10 are in a flowing path until the feed liquid passes through the membrane 13. In this process, the feed liquid has a turbulent effect as it flows on the membrane 13 through the bulges 10, pollutants on the surface of the membrane are continuously taken away, the deposition effect of the pollutants on the surface of the membrane is greatly retarded, and the anti-pollution property of the membrane 13 is greatly improved, which is suitable for treating poor water quality conditions.

When the hydraulic-disc 24 of the present invention is used, the feed liquid comes out of the water distribution groove 9 of one hydraulic-disc 24, then diffuses from the center to the circumference of the membrane 13, flows across the upper surface of the membrane 13 and then goes over to the back side of the membrane 13 in the circumferential direction of the membrane 13, flows to the center in the circumferential direction, flows through the water distribution groove 9 of the next hydraulic-disc 24, and then flows across the next membrane 13. During the process of the feed liquid flowing from the center to the circumference and then from the circumference to the center, a flow area of the feed liquid goes from small to large and then from large to small, and a flow velocity of a cross flow on the corresponding membrane surface is large at the center and small at the circumference. The center of the membrane 13 is fixed by the hydraulic-disc seal ring 14 and has a small flow area, and thus can withstand the highest flow velocity. The membrane 13 at the circumference is in a natural state, and a small flow velocity is advantageous for reducing the impact of the membrane 13, which ensures the service life of the membrane.

In addition to the improvement of the hydraulic-disc seal ring groove 5, in order to further improve the sealing capability, and thus improve the pressure resistance of the disc tube reverse osmosis module, the material of the hydraulic-disc seal ring 14 is also improved according to aspects of the present invention, with the specific content as follows:

In an embodiment, the hydraulic-disc seal ring 14 is made of nitrile rubber, and includes, by mass parts:

100 parts of raw nitrile rubber;

0.1-5 parts of Liquid nitrile rubber-modified graphene oxide;

60-90 parts of liquid nitrile rubber-modified carbon black;

1-3 parts of anti-aging agent;

2-6 parts of compound vulcanizing agent; and

1-3 parts of accelerator.

By mass parts, the nitrile rubber includes 100 parts of raw nitrile rubber. In various embodiments, the Mooney viscosity (ML1+4, 100° C.) of the raw nitrile rubber is preferably 40 to 65, and the mass fraction of acrylonitrile in the raw nitrile rubber is preferably 20-30%. The viscosity of the raw nitrile rubber is not particularly limited, and it is preferable to use N240S and/or N241 type raw nitrile rubber of Japan JSR Co., Ltd., for example. When a mixture of the foregoing two types of raw nitrile rubber is adopted, the present invention does not particularly limit the proportion of the two types of raw nitrile rubber, and any proportion can be adopted.

With the mass parts of the raw nitrile rubber as the basis, the nitrile rubber provided by the present invention includes 0.1-5 parts of liquid nitrile rubber-modified graphene oxide, preferably 0.15-4.8 parts, more preferably 0.5-3.5 parts, further preferably 0.8-2.7 parts. In various embodiments, a small amount of liquid nitrile rubber-modified graphene oxide is added during preparation of the nitrile rubber, which can effectively improve the strength of the seal ring prepared from the nitrile rubber and reduce the compression set thereof, and is beneficial to improving the service life of the seal ring in a stricter use environment.

In various embodiments, the liquid nitrile rubber-modified graphene oxide is preferably obtained by reacting an amino-terminated liquid nitrile rubber with graphene oxide. In various embodiments, the relative molecular mass of the amino-terminated liquid nitrile rubber is preferably 2000-4000. The mass fraction of the amino group in the amino-terminated liquid nitrile rubber is preferably greater than or equal to 15%. In an embodiment, the amino-terminated liquid nitrile rubber is specifically a 1300×16 type amino-terminated liquid nitrile rubber produced by Lubrizol Corporation. In accordance with aspects of the present invention, methods for specifically preparing the liquid nitrile rubber-modified graphene oxide are not particularly limited, as long as the liquid nitrile rubber-modified graphene oxide is prepared using a method well known to those skilled in the art. In various embodiment, the liquid nitrile rubber-modified graphene oxide is prepared by referring to a method in US Patent No. 20150344666A1.

With the mass parts of the raw nitrile rubber as the basis, the nitrile rubber provided by the present invention includes 60-90 parts of liquid nitrile rubber-modified carbon black, preferably 65-85 parts, more preferably 70-80 parts. In various embodiments, the carbon black can increase the hardness of the nitrile rubber and improve tensile strength and the like, but as the amount of carbon black increases, the viscosity of the rubber becomes larger and larger. Especially in the preparation of high hardness (the hardness reaches Shore A 80 or above) nitrile rubber, the amount of carbon black is larger, and the viscosity of the rubber is higher during the subsequent processing, which causes processing difficulties, and heat generated is also increased, which will affect the properties of the rubber after vulcanization. In various embodiments, the liquid nitrile rubber-modified carbon black is used as a raw material to prepare nitrile rubber, which can improve the compatibility of the carbon black and raw nitrile rubber, and the amount of the carbon black added under certain processing conditions is increased, which is beneficial to improving the hardness and strength of the seal ring prepared from the nitrile rubber.

In various embodiments, the liquid nitrile rubber-modified carbon black is preferably obtained by reacting an amino-terminated liquid nitrile rubber with carbon black treated with an epoxy silane coupling agent, specifically, including the following steps: modifying carbon black by using an epoxy silane coupling agent to obtain epoxy silane coupling agent-modified carbon black; and reacting an amino-terminated liquid nitrile rubber with the epoxy silane coupling agent-modified carbon black to obtain liquid nitrile rubber-modified carbon black.

In various embodiments, it is preferable to modify carbon black by using an epoxy silane coupling agent to obtain epoxy silane coupling agent-modified carbon black. In various embodiments, the epoxy silane coupling agent preferably includes one or more of 3-(glycidoxypropyl)triethoxysilane, 3-(glycidoxypropyl)trimethoxysilane (silane coupling agent KH-560), (3-glycidoxypropyl)methyldiethoxysilane, (3-glycidoxypropyl)methyldimethoxysilane, 2-(3,4-epoxycyclohexyl)ethyltriethoxysilane and 2-(3,4-epoxycyclohexyl)ethyltrimethoxysilane. In various embodiments, the carbon black preferably includes semi-reinforcing carbon black and fine particle pyrolysis carbon black, and the mass ratio of the semi-reinforcing carbon black to the fine particle pyrolysis carbon black is preferably (1-8):(2-9), more preferably (2-4):(6-8). In various embodiments, the semi-reinforcing carbon black preferably includes gas furnace process semi-reinforcing carbon black N770 or gas furnace process semi-reinforcing carbon black N774, and the fine particle pyrolysis carbon black preferably includes fine particle pyrolysis carbon black N880. The specific operation steps of the modification treatment are not particularly limited in the present invention, and in some embodiments may be implemented in a manner well known to those skilled in the art. In various embodiments, the carbon black is modified by an epoxy silane coupling agent specifically by referring to the method of the Chinese invention patent CN108084803A.

After epoxy silane coupling agent-modified carbon black is obtained, in various embodiments, an amino-terminated liquid nitrile rubber is reacted with the epoxy silane coupling agent-modified carbon black to obtain liquid nitrile rubber-modified carbon black. In various embodiments, the relative molecular mass of the amino-terminated liquid nitrile rubber is preferably 2000-4000. The mass fraction of the amino group in the amino-terminated liquid nitrile rubber is preferably greater than or equal to 15%. In various embodiments, the amino-terminated liquid nitrile rubber is specifically a 1300×16 type amino-terminated liquid nitrile rubber produced by Lubrizol Corporation. In various embodiments, the mass ratio of the amino-terminated liquid nitrile rubber to the epoxy silane coupling agent-modified carbon black is preferably 5: (0.8-1.2), more preferably 5:1. In various embodiments, the reaction is preferably carried out in the presence of an organic solvent, and the organic solvent preferably includes ethyl acetate; and the mass of the ethyl acetate is preferably 6-7 times that of the amino-terminated liquid nitrile rubber.

In various embodiments, the reaction preferably includes two stages in sequence, where the temperature of the reaction of the first stage is preferably 15-35° C., more preferably 20-25° C., and specifically, the reaction of the first stage can be carried out at room temperature; the time of the reaction of the first stage is preferably 50-70 min, more preferably 60 min; the temperature of the reaction of the second stage is preferably 40-45° C., and the time of the reaction of the second stage is preferably 50-70 min, more preferably 60 min. In various embodiments, it is preferred to carry out the reaction under the foregoing conditions, and the amino-terminated liquid nitrile rubber and the epoxy silane coupling agent-modified carbon black can be sufficiently reacted, and the reaction rate can be well controlled, which is advantageous for improving the safety of the reaction.

After completion of the reaction, in various embodiments, the obtained system is preferably filtered, and the solid is filtered out and washed with ethyl acetate 3-5 times, and dried to obtain liquid nitrile rubber-modified carbon black. The present invention has no special restriction on the filtration, washing and drying, and a manner well known to those skilled in the art may be adopted.

With the mass parts of the raw nitrile rubber as the basis, the nitrile rubber provided includes 1-3 parts of anti-aging agent, preferably 1.2-2.5 parts, more preferably 1.5-2.0 parts. In various embodiments, the anti-aging agent preferably includes one or more of an anti-aging agent 2246, an anti-aging agent RD, and an anti-aging agent 4020, and is more preferably the anti-aging agent 2246.

With the mass parts of the raw nitrile rubber as the basis, the nitrile rubber provided includes 2-6 parts of compound vulcanizing agent, preferably 3-5 parts. In various embodiments, the compound vulcanizing agent preferably includes sulfur and a peroxide vulcanizing agent, and the peroxide vulcanizing agent preferably includes dicumyl peroxide; and a mass ratio of the sulfur to the dicumyl peroxide is preferred (1-3):(7-9).

With the mass parts of the raw nitrile rubber as the basis, the nitrile rubber provided includes 1-3 parts of accelerator, preferably 1.5-2.5 parts. In various embodiments, the accelerator preferably includes one or more of triallyl cyanurate, triallyl isocyanurate, and N,N′-m-phenylene dimaleimide, and more preferably includes the triallyl cyanurate or the triallyl isocyanurate.

In accordance with aspects of the present invention, provided is a method for preparing the nitrile rubber according to the above technical solution, which includes the following steps:

mixing a raw nitrile rubber, an anti-aging agent, liquid nitrile rubber-modified graphene oxide, liquid nitrile rubber-modified carbon black, a compound vulcanizing agent, and an accelerator to obtain a nitrile rubber.

In various embodiments, a method for preparing the nitrile rubber preferably includes the following steps:

performing first mill run press fit on a raw nitrile rubber to obtain a first mill run press fit material;

mixing the first mill run press fit material with an anti-aging agent and then performing second mill run press fit to obtain a second mill run press fit material;

mixing the second mill run press fit material with liquid nitrile rubber-modified graphene oxide and liquid nitrile rubber-modified carbon black and then performing third mill run press fit to obtain a third mill run press fit material;

mixing the third mill run press fit material with a compound vulcanizing agent and an accelerator and then performing fourth mill run press fit to obtain a fourth mill run press fit material; and performing fifth mill run press fit on the fourth mill run press fit material to obtain a nitrile rubber.

In various embodiments, the entire process of preparing the nitrile rubber is preferably carried out on a three-roller machine.

In various embodiments, preferably, the first mill run press fit is performed on a raw nitrile rubber to obtain a first mill run press fit material. In various embodiments, in the first mill run press fit process, the roller spacing of the three-roller machine is preferably 1-2 mm, and the time for the first mill run press fit is preferably 5-10 min.

After the first mill run press fit material is obtained, preferably, the first mill run press fit material is mixed with an anti-aging agent and then second mill run press fit is performed to obtain a second mill run press fit material. In various embodiments, in the second mill run press fit process, the roller spacing of the three-roller machine is preferably 2-3 mm; and the time for the second mill run press fit is preferably 2-3 min.

After the second mill run press fit material is obtained, preferably, the second mill run press fit material is mixed with liquid nitrile rubber-modified graphene oxide and liquid nitrile rubber-modified carbon black and then third mill run press fit is performed to obtain a third mill run press fit material. In various embodiments, a mixture of the liquid nitrile rubber-modified graphene oxide and the liquid nitrile rubber-modified carbon black is added in 3-5 batches. In the third mill run press fit process, the roller spacing of the three-roller machine is preferred 4-6 mm, and after the mixture of the liquid nitrile rubber-modified graphene oxide and the liquid nitrile rubber-modified carbon black is added every time, and the time for the mill run press fit is preferably 10-15 min. In various embodiments, by adding the mixture of the liquid nitrile rubber-modified graphene oxide and the liquid nitrile rubber-modified carbon black in batches, the dispersibility of the liquid nitrile rubber-modified graphene oxide and the liquid nitrile rubber-modified carbon black in the raw nitrile rubber can be improved, which enables the liquid nitrile rubber-modified graphene oxide and the liquid nitrile rubber-modified carbon black to fully play the role, and finally the nitrile rubber with excellent mechanical properties is prepared.

After the third mill run press fit material is obtained, preferably, the third mill run press fit material is mixed with a compound vulcanizing agent and an accelerator and then fourth mill run press fit is performed to obtain a fourth mill run press fit material. In various embodiments, in the fourth mill run press fit process, the roller spacing of the three-roller machine is preferably 4-6 mm, and the time for the fourth mill run press fit is preferably 2-3 min.

After the fourth mill run press fit material is obtained, preferably, fifth mill run press fit is performed on the fourth mill run press fit material to obtain a nitrile rubber. In various embodiments, in the fifth mill run press fit process, the roller spacing of the three-roller machine is preferably 1-2 mm, and the time for the fifth mill run press fit is preferably 3-5 min.

After completion of the fifth mill run press fit, preferably, the obtained system is cooled to room temperature (the aforementioned process from the first mill run press fit to the fifth mill run press fit is preferably performed at room temperature, but the mill run press fit generates frictional heat to make the temperature of the material rise, and thus preferably the system is cooled to room temperature and then subsequent processing is performed), mill run press fit is continued twice, and batch-out is performed to obtain a nitrile rubber. In various embodiments, in the last two-time mill run press fit process, the roller spacing of the three-roller machine is preferably 2-3 mm, and the time for the mill run press fit performed every time is preferably 2-3 min.

In accordance with aspects of the present invention, provided is a seal ring which is prepared from the nitrile rubber in the foregoing technical solution or the nitrile rubber prepared by using the preparation method in the foregoing technical solution as a raw material. In various embodiments, preferably, with the nitrile rubber as a raw material for preparation, a seal ring is prepared by injection compression molding, transfer compression molding or flat plate compression molding. The present invention has no special restriction on an operating manner for the injection compression molding, transfer compression molding or flat plate compression molding, and a manner well known to those skilled in the art may be adopted. In various embodiments, the seal ring is specifically prepared by a flat plate compression molding method, where the flat plate compression molding is preferably carried out under conditions of 1.5-2.5 MPa and 175-185° C.

The technical solution provided by the present invention will be apparent from the various embodiments described below. The described embodiments are merely some, rather than all, of the embodiments illustrative of the present invention. All other embodiments obtained by general technical personnel in the field based on the embodiments described herein, achieved without creative efforts, shall fall within the protection scope of the present invention.

### Embodiments 1-8

Preparation of liquid nitrile rubber-modified graphene oxide (abbreviated as LNBR-GO):

Liquid nitrile rubber-modified graphene oxide was prepared by using a method of US patent NO. US20150344666A1, where an amino-terminated liquid nitrile rubber (abbreviated as ATBN) was purchased from Lubrizol Corporation, and was specifically a 1300×16 type amino-terminated nitrile rubber liquid.

Preparation of liquid nitrile rubber-modified carbon black (abbreviated as LNBR-C):
carbon black was modified by using an epoxy silane coupling agent (specifically, a silane coupling agent KH-560) according to the method of the Chinese invention patent NO. CN108084803A to obtain epoxy silane coupling agent-modified carbon black;
by mass parts, 1 part of epoxy silane coupling agent-modified carbon black was dispersed in 30 parts of ethyl acetate, and 5 parts of amino-terminated liquid nitrile rubber (abbreviated as ATBN, purchased from Lubrizol Corporation, specifically being a 1300×16 type) was added, the reaction was performed with stirring at room temperature (25° C.) for 1 h, and keep stirring for another 1 h when the temperature was raised to 40° C.; after the reaction was completed, filtering out the obtained solid and washing it with ethyl acetate three times, and then the liquid nitrile rubber-modified carbon black was obtained after drying.

The preparation raw materials in Embodiments 1-8 were selected as follows, and the specific types and amounts are listed in Table 1:

A raw nitrile rubber was N240S and/or N241 type raw nitrile rubber of Japan JSR Co., Ltd.;

LNBR-GO was prepared according to the foregoing method;

LNBR-C was prepared according to the foregoing method, where carbon black used was semi-reinforcing carbon black (gas furnace process semi-reinforcing carbon black N770 or gas furnace process semi-reinforcing carbon black N774) and fine particle pyrolysis carbon black (fine particle pyrolysis carbon black N880);

an anti-aging agent was an anti-aging agent 2246;

a compound vulcanizing agent was sulfur and dicumyl peroxide;

and an accelerator was triallyl cyanurate or triallyl isocyanurate.

The preparation of the nitrile rubber using the foregoing preparation raw materials includes the following steps:

performing mill run press fit on the raw nitrile rubber for 8 min on a three-roller machine under the conditions of a roller spacing of 2 mm; adding the anti-aging agent, performing mill run press fit for 3 min under the conditions of a roller spacing of 2 mm; adding the LNBR-GO and the LNBR-C in 4 batches, performing mill run press fit under the conditions of a roller spacing of 5 mm, and fit for 10 min after each feeding; adding the compound vulcanizing agent and the accelerator, and performing mill run press fit for 3 min under the conditions of a roller spacing of 5 mm; adjusting the roller spacing to 1 mm, performing mill run press fit for 3 min and then cooling to room temperature, continuing to perform mill run press fit twice (the roller spacing is 2 mm and the time for mill run press fit performed every time is 2 min), and performing batch-out to obtain a nitrile rubber.

The preparation of a seal ring by using the nitrile rubber includes the following steps:

performing flat plate compression molding on the nitrile rubber under the conditions of 2 MPa and 180° C. to obtain a seal ring.

TABLE 1
Types and amounts of preparation raw materials in Embodiments 1-8

| Types of prepared | | Amounts (mass parts) of preparation raw | | | | | | | |
|---|---|---|---|---|---|---|---|---|---|
| raw materials in | | materials in Embodiments 1-8 | | | | | | | |
| Embodiments 1-8 | | 1 | 2 | 3 | 4 | 5 | 6 | 7 | 8 |
| Raw nitrile | N240S | 100 | 15 | 35 | 45 | 60 | 75 | 90 | 0 |
| rubber | N241 | 0 | 85 | 65 | 55 | 40 | 25 | 10 | 100 |
| LNBR-GO | | 0.15 | 0.5 | 0.8 | 1.1 | 1.9 | 2.7 | 3.5 | 4.8 |
| LNBR-C | N770 | 6 | 12 | 10 | 25 | 27 | 10 | 0 | 0 |
| | N774 | 0 | 0 | 12 | 0 | 0 | 16 | 24 | 42 |
| | N880 | 54 | 52 | 50 | 60 | 63 | 64 | 56 | 43 |
| Anti-aging agent 2246 | | 1.2 | 1.5 | 2.0 | 3.0 | 2.5 | 2.0 | 2.0 | 1.8 |
| Compound | Sulfur | 0.4 | 1.2 | 1 | 1 | 1 | 1 | 1 | 1 |
| vulcanizing | Dicumyl | 3.6 | 3 | 4 | 4 | 4 | 4 | 4 | 4 |
| agent | peroxide | | | | | | | | |
| Accelerator | Triallyl | 1.5 | 2 | 2.5 | 3 | 0 | 0 | 0 | 0 |
| | cyanurate | | | | | | | | |
| | Triallyl | 0 | 0 | 0 | 0 | 2.5 | 3 | 2.5 | 3 |
| | isocyanurate | | | | | | | | |

### Comparative Example 1

By weight parts, 100 parts of raw nitrile rubber (composed of 60 parts of N240S and 40 parts of JSR®N241), 1.1 parts of LNBR-GO, 85 parts of carbon black (composed of 20 parts of N770 and 60 parts of N880), 10 parts of dioctyl phthalate (softener, abbreviated as DOP), 2.5 parts of anti-aging agent 2246, 5 parts of compound vulcanizing agent (composed of 1 part of sulfur and 4 parts of dicumyl peroxide) and 2 parts of triallyl cyanurate were processed according to the method in the foregoing embodiment to obtain nitrile rubber, and a seal ring was further prepared.

### Comparative Example 2

By weight parts, 100 parts of raw nitrile rubber (composed of 60 parts of N240S and 40 parts of JSR®N241), 85 parts of carbon black (composed of 20 parts of N770 and 60 parts of N880), 10 parts of softener DOP, 2.5 parts of anti-aging agent 2246, 5 parts of compound vulcanizing agent (composed of 1 part of sulfur and 4 parts of dicumyl peroxide) and 2 parts of triallyl cyanurate were processed according to the method in the foregoing embodiment to obtain nitrile rubber, and a seal ring was further prepared.

Performance Test

The properties of the nitrile rubbers and seal rings obtained in Embodiments 1-8 and Comparative Examples 1 and 2 were tested, specifically as follows:

Minimum torque M_{L}: The minimum torque M_{L} of the nitrile rubber was tested using a vulcameter according to a method in ASTM D-2084; the lower the M_{L} value, the greater the viscosity of the rubber, the more difficult the processing.

Tensile strength: 25° C., the seal ring was tested according to GB/T528-2009 requirements.

Shore A hardness: 25° C., the seal ring was tested according to GB/T531-2009 requirements.

Compression set: The seal ring was tested according to the requirements of GB/T1683-2018. The test temperature was 100° C., the test time was 22 h and 30 h respectively, the compression ratio of samples was 30%, and a limiter with a height of 8 mm was selected; a compression set obtained when the test time was 22 h was recorded as a compression set 1 (abbreviated as deformation 1), and a compression set obtained when the test time was 30 h was recorded as a compression set 2 (abbreviated as deformation 2). The larger the increase ratio of the deformation 2 relative to the deformation 1 is, the easier the deformation of the seal ring is, and the shorter the service life is.

Running time: the seal ring was installed in a reverse osmosis device and operated according to the actual operating conditions. The reverse osmosis pressure was 25 MPa, and the leakage time was observed. The longer the running time is, the longer the service life of the seal ring is.

The results of the above performance test are shown in Table 2.

TABLE 2
Performance test results of nitrile rubbers and seal rings
in Embodiments 1-8 and Comparative Examples 1 and 2

| Embodiments and | | Tensile | Hardness | | | | Running |
|---|---|---|---|---|---|---|---|
| comparative | M_{L}/ | strength/ | (Shore A)/ | Deformation | Deformation | Increase | time/ |
| examples | dN · m | MPa | degrees | 1/% | 2/% | proportion/% | month |
| Embodiment 1 | 1.35 | 27 | 63 | 18.3 | 23.5 | 28.4 | 7 |
| Embodiment 2 | 1.42 | 25 | 68 | 17.1 | 22.7 | 32.7 | 6.5 |
| Embodiment 3 | 1.48 | 22 | 72 | 17.3 | 23.1 | 33.5 | 6 |
| Embodiment 4 | 1.59 | 25 | 76 | 17.9 | 23.2 | 29.6 | 6.5 |
| Embodiment 5 | 1.75 | 23 | 88 | 19.2 | 24.7 | 28.6 | 7 |
| Embodiment 6 | 1.72 | 21 | 91 | 18.9 | 24.5 | 29.6 | 7 |
| Embodiment 7 | 1.64 | 26 | 81 | 18.3 | 24.1 | 31.7 | 6.5 |
| Embodiment 8 | 1.69 | 23 | 85 | 18.8 | 24.8 | 31.9 | 6.5 |
| Comparative | 1.98 | 19 | 82 | 20.3 | 28.5 | 40.4 | 4 |
| Example 1 | | | | | | | |
| Comparative | 1.92 | 18 | 83 | 21.6 | 30.5 | 41.2 | 4 |
| Example 2 | | | | | | | |

It can be seen from the results of Table 2 that the nitrile rubber provided in accordance with aspects of the present invention has better processability, even if more carbon black is added. The seal ring prepared in accordance with aspects of the present invention has better tensile resistance, and even if the Shore A hardness reaches 85 degrees or more, the tensile strength also reaches 20 MPa or more. And the seal ring prepared in in accordance with aspects of the present invention has a better compression set, has a long service life in practical applications, and can be used as a seal ring for a reverse osmosis device in the case of high reverse osmosis pressure application.

Specific embodiments described in this specification are intended to be illustrative of the principles and implementations of the present invention. The description of the aforementioned embodiments is only used for facilitating understanding of the method and the core ideas associated with the present invention. Those of general technical knowledge in the field, will appreciated that changes in specific implementations and application will still fall within the scope of the present invention. In conclusion, the scope of the present invention shall be defined by the claims, the construction of which shall not be unduly limited by the contents of this specification or the embodiments described herein.

What is claimed is:

1. A disc tube reverse osmosis module, comprising:
a tie-rod, a top flange, an end flange, upper lock nuts, lower lock nuts, hydraulic-disc assemblies, membrane-cushions, a water inlet, a concentrate receiving pipe, a permeate collector, a permeate receiving pipe, and a pressure vessel, wherein:
both ends of the tie-rod have external threads;
the hydraulic-disc assembly comprises a hydraulic-disc and hydraulic-disc seal rings mounted in a lip seal groove on the hydraulic-disc, and the hydraulic-disc assemblies and the membrane-cushions are sequentially alternately disposed and coaxially sleeve the outside of the tie-rod from top to bottom;
the number of the hydraulic-disc assemblies is one more than that of the membrane-cushions; the top flange and the end flange sleeve the tie-rod and clamp the hydraulic-disc assemblies and the membrane-cushions there between;
the top flange is in sealing connection with the tie-rod;
the upper lock nut is in threaded connection with the top of the tie-rod and located above the top flange;
the upper lock nut is configured to exert downward locking force on the top flange;
a plurality of water distribution ports are evenly distributed in a circumferential direction on the edge of the lower surface of the top flange;
a gap is reserved between the end flange and the tie-rod;
the permeate collector sleeves the tie-rod and is in sealing connection with the lower side of the end flange, and a gap is reserved between the end of the permeate collector which is adjacent to the end flange and the tie-rod;
the lower lock nut is in threaded connection with the lower end of the tie-rod and located below the permeate collector, and the lower lock nut is configured to exert an upward locking force on the permeate collector;
one end of the permeate receiving pipe is fixedly connected to the permeate collector, it is communicated with the gap between the permeate collector and the tie-rod;
the inner surface of the pressure vessel is respectively in sealing connection with the top flange and the end flange, and a gap is reserved between the hydraulic-discs and the pressure vessel;
the water inlet and the concentrate receiving pipe are fixed on the end flange, the end flange is provided with a water inlet flow channel and a water outlet flow channel; and
the water inlet is communicated with the gap between the hydraulic-discs and the pressure vessel through the water inlet flow channel, and the concentrate receiving pipe is communicated with a water distribution groove on the hydraulic-discs through the water outlet flow channel.

2. The apparatus of claim 1, wherein the top flange and the end flange are each in sealing connection with the pressure vessel through a lip seal in a mounting groove corresponding to the lip seal, and openings of the two lip seals are oppositely disposed.

3. The apparatus of claim 1, wherein:
a top flange sealing shaft sleeve is disposed between the top flange and the tie-rod;
the top flange sealing shaft sleeve sleeves the tie-rod;
the inner side of the top flange sealing shaft sleeve is in sealing connection with the tie-rod through an inner seal ring in the sleeve; and
the outer side of the top flange sealing shaft sleeve is in sealing connection with the top flange through an outer seal ring of the sleeve, and the top flange sealing shaft sleeve is provided with a seal ring groove for mounting the inner seal ring and the outer seal ring of the sleeve.

4. The apparatus of claim 1, wherein the disc tube reverse osmosis module further comprises a tie-rod cushion block, wherein the cushion block sleeves the outer side of the tie-rod, and both ends of the cushion block abut against the upper lock nut and the top flange, respectively.

5. The apparatus of claim 1, wherein:
an end of the permeate collector that is away from the end flange is in sealing connection with the tie-rod through an inner seal ring of the permeate collector;
a groove is disposed at the center of the lower surface of the end flange; and
the end of the permeate collector close to the end flange abuts against the bottom of the groove and is in sealing connection with a groove wall through an outer seal ring of the permeate collector, and the permeate collector is provided with a seal ring groove for mounting the inner and the outer seal rings.

6. The apparatus of claim 1, wherein the hydraulic-disc comprises:
a hydraulic-disc body, wherein multiple bulges are arranged on both the front side and back side;
the bulges are annularly and uniformly distributed by taking the center of the hydraulic-disc body as the center of a circle, there are the same cycle numbers of the bulges on the front side and the back side of the hydraulic-disc body, and diameters of the cycles of the bulges are mutually corresponding;
radial water distribution ribs, wherein multiple radial water distribution ribs are annularly and uniformly distributed by taking the center of the hydraulic-disc body as the center of a circle, a water distribution groove is formed between two adjacent water distribution ribs, and a first end of each radial water distribution rib is fixedly connected with an inner edge of the hydraulic-disc body;
an inner support ring, wherein a second end of each radial water distribution rib is fixedly connected with the outer edge of the inner support ring, an annular boss is arranged on the front side of the inner support ring, a hydraulic-disc seal ring groove is respectively arranged at corresponding positions of the front side and back side of the inner support ring, the outer side groove wall of the hydraulic-disc seal ring groove is serrated, the hydraulic-disc seal ring groove is located on the outer side of the annular boss, multiple permeate receiving grooves are annularly and uniformly distributed on the inner surface of the inner support ring, the permeate receiving grooves are axial through grooves, the depth of the permeate receiving groove is greater than the width of the annular boss, locating pins and locating holes are arranged on the front side and the back side of the annular boss, respectively and the locating holes are used for allowing insertion of the locating pins; and
an outer support ring, wherein the inner edge of the outer support ring is fixedly connected with the outer edge of the hydraulic-disc body, and the inner support ring, the outer support ring, the hydraulic-disc body, the annular boss and the hydraulic-disc seal ring grooves are concentric.

7. The apparatus of claim 6, wherein:
the membrane-cushion comprises two reverse osmosis membrane-cushions and a supporting net;
the supporting net is clamped between the two reverse osmosis membrane-cushions; and
the supporting net and the reverse osmosis membrane-cushions have a concentric annular structure, and the two reverse osmosis membrane-cushions are connected to the outer edge of the supporting net by ultrasonic welding.

8. The apparatus of claim 7, wherein the innermost cycle of the bulges on the front side and the back side of the hydraulic-disc body and the corresponding radial water distribution ribs have the same position angles.

9. The apparatus of claim 8, wherein:
there are two position relations of each cycle of the bulges on the front side and the back side of the hydraulic-disc body and the radial water distribution ribs, wherein in:
one position relation is any bulge of the cycle and one radial water distribution rib have the same position angle, and
the other position relation is any bulge of the cycle is located on the central surface of the water distribution groove, and the two position relations are distributed alternatively.

10. The apparatus of claim 1, wherein the hydraulic-disc seal ring is made of nitrile rubber, containing the following preparation raw materials in parts by mass:
100 parts of raw nitrile rubber;
0.1-5 parts of liquid nitrile rubber-modified graphene oxide;
60-90 parts of liquid nitrile rubber-modified carbon black;
1-3 parts of anti-aging agent;
2-6 parts of compound vulcanizing agent; and
1-3 parts of accelerator.
